(19) United States
(12) Patent Application Publication
(10) Pub. No.: US 2025/0102394 A1
(43) Pub. Date: Mar. 27, 2025

(54) AUTOMATICALLY IDENTIFYING DEPOSITIONS OR LEAKS IN HYDROCARBON WELL CONDUITS

(71) Applicant: Halliburton Energy Services, Inc., Houston, TX (US)

(72) Inventors: Philippe Quero, Houston, TX (US); Graham Jack, Newburgh (GB); Antonio Acquaah, Houston, TX (US); Chalice Young, Houston, TX (US); Sandeep Pawar, Katy, TX (US); Oluwatosin Ogundare, The Woodlands, TX (US); David Bennett, Houston, TX (US)

(21) Appl. No.: 18/476,074

(22) Filed: Sep. 27, 2023

(51) Int. Cl. G01M 3/28; E21B 47/117

(52) U.S. Cl. CPC G01M 3/2815; E21B 47/117

(57) ABSTRACT

A machine learning-based system for automatically identifying and locating depositions or leaks in a conduit associated with a hydrocarbon well operation. The system may train a machine learning model using a training dataset comprising a multitude of measured pressure data samples received from a conduit monitoring system that operates by introducing a pressure wave into a conduit and using a sensor to measure the magnitude of pressure waves reflected by surfaces or objects in the conduit. The pressure data samples can be filtered to remove noise and focus on a frequency range of interest prior to being used to train the machine learning model. The machine learning model may be trained, using key attributes of the pressure data samples, to generate a predictive model that can predict a deposition or leak in a conduit of interest based on new measured pressure data associated with the conduit of interest.

### TECHNICAL FIELD

The present disclosure relates generally to hydrocarbon well operations, and more particularly although not necessarily exclusively, to the automated identification of hydrocarbon well conduit anomalies such as depositions or leaks.

### BACKGROUND

Understanding the condition of different hydrocarbon well production stages or components, such as the condition of a well conduit in the form of a wellbore, flowline, or pipeline, can allow a hydrocarbon well operator to better control and maximize production operations. Likewise, the ability to automatically locate and identify abnormal hydrocarbon well conduit conditions in real time is useful, as undetected or improperly identified anomalous conduit conditions can result in conduit damage, production reductions, or shutdowns.

### BRIEF DESCRIPTION OF THE DRAWINGS

FIG. 1 is a schematic diagram of system for identifying and locating depositions or leaks in a wellbore of a hydrocarbon well operation according to one example of the present disclosure.

FIG. 2 depicts a computing environment including a computing system configured to execute a machine learning model for identifying and locating depositions or leaks in a hydrocarbon well conduit according to one example of the present disclosure.

FIG. 3 is a block diagram of a computing system for identifying and locating depositions or leaks in a hydrocarbon well conduit according to one example of the present disclosure.

FIG. 4 is a graphical representation of the thickness and location of a deposition in a conduit as calculated by a deposition and leak detection system based on conduit pressure data received from a conduit monitoring system according to one example of the present disclosure.

FIG. 5 is a visual representation of a conduit deposition profile as calculated by a deposition and leak detection system based on conduit pressure data received from a conduit monitoring system according to one example of the present disclosure.

FIG. 6 is a flow chart representing a method of training a machine learning model to identify and locate a deposition or a leak in a hydrocarbon well conduit according to one example of the present disclosure.

### DETAILED DESCRIPTION

Certain aspects and examples of the present disclosure relate to a system for identifying and locating anomalies such as depositions or leaks in a hydrocarbon well operation conduit (also referred to herein as “conduit”) by training a machine learning model and applying the machine learning model to pressure measurements obtained from a conduit monitoring system for a conduit of interest. Conduit monitoring system examples may be configured to record pressure within a conduit and can be installed to, for example and without limitation, hydrocarbon well operation conduits in the form of wellbore casings, flowlines, and pipelines. Conduit monitoring system examples may use a combination of sensors and data acquisition devices to generate data indicative of pressure conditions inside a conduit. The data may serve as training data and can be provided to a computing device of a deposition and leak detection system for training a machine learning model to generate a predictive model that can subsequently be applied to pressure measurements for a conduit of interest to predict and locate a deposition or a leak in the conduit of interest.

A conduit monitoring system used to provide data to a system for identifying and locating depositions or leaks operates by introducing a pressure wave into the fluid flowing in the conduit, and using one or more sensors to measure the magnitude of pressure wave reflections caused by anomalies such as depositions or leaks in the conduit. A leak of fluid from a conduit, such as through a hole or crack in the conduit, can also naturally generate a pressure wave in the conduit. Pressure data generated by the sensor(s) can be recorded, stored or otherwise collected, and can be provided to a deposition and leak detection system for purposes of training a machine learning model, or for predictive purposes when the pressure data is associated with a conduit of interest.

Pressure data collected by a conduit monitoring system can be automatically transmitted to a computing device of the deposition and leak detection system. The computing device of the deposition and leak detection system may access training data produced by the conduit monitoring system to generate a trained machine learning model (predictive model), and may subsequently apply the predictive model to new pressure data associated with a conduit of interest to predict a deposition or a leak in the conduit of interest, which prediction can include the location of the deposition or leak.

The machine learning model is preferably also trained on at least one key attribute, which may be a plurality of key attributes. For example, the machine learning model can be trained to recognize the point in the collected pressure data at which introduction of a pressure wave into a monitored conduit begins (e.g., at valve opening). This typically results in the largest point of created acoustic energy in the conduit during a test. Similarly, the machine learning model can be trained to recognize the point in the collected pressure data at which the mechanism used to introduce the pressure pulse into the monitored conduit is turned off (e.g., at valve closing), or the point at which the pressure in the conduit begins to recover after introduction of the pressure wave. The slope of the pressure data or the slope of the first derivative of the pressure data at one or more given points during a test may also be analyzed in this regard. For purposes of generating a first (and perhaps second) derivative of the pressure and training the machine learning model to recognize such key attributes, the pressure data may be transformed by a technique such as fast Fourier transformation (FFT).

The machine learning model can further be trained on other key attributes associated with the conduit being monitored, such as for example, the length of the conduit. Training the machine learning model using the length of the conduit as a key attribute, for example, can further allow for training of the machine learning model on pressure data collected only during a time period of interest, while pressure data collected prior to or after the time period of interest can be excluded. This can further help the machine learning model to understand what the pressure data of interest looks like and to align the pressure data with the goal of minimizing standard deviation or minimized mean average between blockage or leak location calculations.

It is possible for different examples of the machine learning model to be trained using supervised, semi-supervised, or unsupervised machine learning methods. In at least one example, the trained (predictive) model may be, for example, a classification model. In another example, the predictive model may be a regression model. Artificial neural networks and deep learning may also be employed to generate a predictive model.

An example of a deposition and leak detection system can report an identified deposition or a leak in a conduit, such as to personnel responsible for operating or maintaining the affected conduit of the hydrocarbon well operation. Another example of a deposition and leak detection system can, in response to determining the presence of a deposition or leak in a conduit of interest, schedule a maintenance procedure, initiate a remediation action such as by launching a cleaning pig or a robotic conduit leak repair device, or take other appropriate actions relative to the deposition or leak. In any case, using a deposition and leak detection system to apply a properly trained machine learning model to sensor data obtained from a conduit monitoring system as described herein, can result in the accurate identification and location of depositions and leaks in a conduit.

In addition to using deposition and leak detection system examples to identify and locate a deposition or leak in a given conduit, a deposition and leak detection system can use sensor data from a conduit monitoring system in various other ways. For example, a deposition and leak detection system can use sensor data collected from an existing hydrocarbon well flowline, pipeline, or wellbore, in a predictive modeling application relative to future hydrocarbon well operations, such as but not limited to wellbore, flowline, or pipeline design, maintenance scheduling, etc.

Illustrative examples follow, and are given to introduce the reader to the general subject matter discussed herein rather than to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

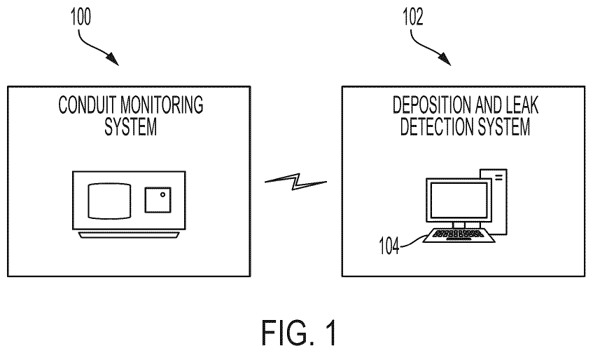

A conduit monitoring system 100 for monitoring and reporting the conditions within a conduit of interest is depicted in FIG. 1, along with a deposition and leak detection system 102 that is communicatively coupled to the conduit monitoring system 100. The conduit monitoring system 100 operates by introducing a pressure wave into the fluid within a conduit, and as the pressure wave propagates therein, uses one or more sensors to measure the magnitude of reflected pressure waves caused by depositions or leaks in the conduit.

The conduit monitoring system 100 records, stores or otherwise collects pressure data generated by the sensor(s) in response to the receipt of pressure wave reflections traveling in the conduit. As indicated, the pressure data collected by the conduit monitoring system 100 can be transmitted by the conduit monitoring system 100 to a computing device 104 of the deposition and leak detection system 102 for analysis. The pressure data may be transmitted to the computing device 104 of the deposition and leak detection system 102 as determined by the conduit monitoring system 100, at the request of the computing device 104 of the deposition and leak detection system 102, or otherwise. The computing device 104 of the deposition and leak detection system 102 can reside locally to the components of the conduit monitoring system 100 and may be communicatively coupled thereto via a local interface. Alternatively, the computing device 104 and the deposition and leak detection system 102 can reside remotely from the components of the conduit monitoring system 100, and the computing device 104 may receive pressure data from the conduit monitoring system 100 over a network, such as but not limited to the Internet. Communications between the conduit monitoring system 100 and the deposition and leak detection system 102 may be wired or wireless communications. Wireless communications between the conduit monitoring system 100 and the computing device 104 of the deposition and leak detection system 102 are indicated in FIG. 1 for purposes of illustration.

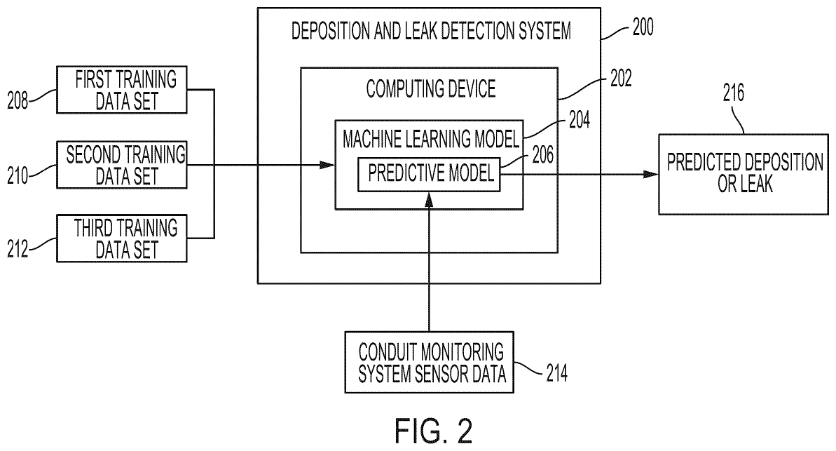

FIG. 2 depicts a computing environment including a deposition and leak detection system 200 having a computing device 202 configured to train a machine learning model 204 and to execute a trained (predictive) model 206 to identify and locate depositions or leaks in a hydrocarbon well conduit according to one example. The machine learning model may be trained on one or more of a first training dataset 208, a second training dataset 210, and a third training dataset 212, as is described in more detail below. In some examples, it is possible to train the machine learning model 204 on only one or the other of the first training dataset 208 and the second training dataset 210, or the first training dataset 208 and the third training dataset 212. The first training dataset 208, second training dataset 210, and third training dataset 212 may be stored in a memory (e.g., on a local drive) of the computing device 202, or on a network drive, a cloud storage system, or any other applicable storage medium.

The computing device 202 of the deposition and leak detection system 200 can utilize existing pressure data as the training data for training the machine learning model 204, particularly pressure data obtained through past operation of a conduit monitoring system, such as but not limited to the conduit monitoring system 100 shown in FIG. 1, and correspondingly described above. In an example, the first training dataset 208 may be comprised of a multitude of measured pressure data samples recorded or otherwise obtained by a sensor of a conduit monitoring system when monitoring an ideal hydrocarbon well conduit-meaning that the conduit contains no anomalous structures, objects, or conditions such as depositions or leaks. The pressure data samples may be obtained over the course of multiple tests of the conduit by a conduit monitoring system. In an example, the second training dataset 210 may be comprised of a multitude of measured pressure data samples recorded or otherwise obtained by a conduit monitoring system over the course of multiple tests when monitoring a hydrocarbon well conduit having a deposition. In an example, the third training dataset 212 may be comprised of a multitude of measured pressure data samples recorded or otherwise obtained by a conduit monitoring system obtained over the course of multiple tests when monitoring a hydrocarbon well conduit having a leak.

In an example, the machine learning model can be trained on only a portion of the available training data of the training datasets 208, 210, 212 while another portion or the remainder of the training data of the training datasets 208, 210, 212 can be withheld for subsequent use in validating the predictive model. That is, once the predictive model 206 is generated through training of the machine learning model 204, the predictive model 206 may be validated against the portion of the first training dataset 208, the second training dataset 210, and/or the third training dataset 212 held in reserve. It is also possible to validate the predictive model 206 against results generated relative to the same pressure data by a physics-based model that is known to be accurate.

The machine learning model 204 may be trained, according to an example, using a supervised learning method. In a supervised learning method example, the pressure data contained in the first training dataset 208, the second training dataset 210, and the third training dataset 212 is labeled. As such, the machine learning model 204 knows during the training process that the training data of the first training dataset 208 is representative of pressure measurements made by a conduit monitoring system relative to an ideal hydrocarbon well conduit. Likewise, the machine learning model 204 knows during the training process that the training data of the second training dataset 210 is representative of pressure signals measurements made by a conduit monitoring system relative to a hydrocarbon well conduit that has a deposition, and that the training data of the third training dataset 212 is representative of pressure signals measurements made by a conduit monitoring system relative to a hydrocarbon well conduit that has a leak. It is also possible to train the machine learning model 204 on a single dataset comprising appropriately labeled pressure data that is representative of the pressure within an ideal conduit, a conduit a having a deposition, and a conduit having a leak.

In an example, a supervised learning method may be a supervised classification learning method executed by a classification algorithm such that the predictive model 206 is a classification model. Various types of classification algorithms may be utilized for this purpose, such as without limitation, Naïve Bayes, logistic regression, decision tree, support vector machine, and random forest classification algorithms. Other appropriate classification algorithms known to those of skill in the art may also be used. The output of the predictive model 206 in such an example may be a prediction (predictive output) 216 of the presence and location of a deposition and/or a leak within a conduit of interest based on new pressure (sensor) data 214 from an associated conduit monitoring system to which the predictive model 206 is subsequently applied.

In another supervised learning example, the predictive model 206 may instead be a supervised regression learning method executed by a regression algorithm such that the predictive model 206 is a regression model. Various types of regression algorithms may be utilized for this purpose, such as without limitation, neural network, linear regression, decision tree, support vector machine, and random forest regression algorithms. Other appropriate regression algorithms known to those of skill in the art may also be used. The output of the predictive model 206 in such an example may be a predicted likelihood that a deposition or leak is present in a conduit of interest, or a forecast of the likelihood that a deposition or leak will occur in a conduit of interest based on detected patterns in pressure data received over time.

The machine learning model 204 may also be trained, according to an example, using a semi-supervised learning method. In a semi-supervised learning method example, only some of the pressure data contained in the first training dataset 208, the second training dataset 210, and the third training dataset 212 is labeled, and the machine learning model 204 can be trained only on the partially labeled pressure data in the second training dataset 210 or the third training dataset 212, or on the partially labeled pressure data in both the first training dataset 208 in combination with the second training dataset 210 and/or the third training dataset 212. As such, the machine learning model 204 is unaware whether some of the training data on which it is trained comprises pressure data that is representative of an ideal conduit or a conduit having a deposition and/or a leak. To overcome this issue, learning that occurs during training of the machine learning model 204 on pressure data that is labeled can be used to predict a label for the unlabeled pressure data. The pressure data with predicted labels can then be used to retrain the machine learning model 204 or to train a new machine learning model. The predictive model 206 resulting from training the machine learning model 204 using a semi-supervised learning method, may again be a classification model or a regression model.

The machine learning model 204 may also be trained, according to an example, using an unsupervised learning method. In an unsupervised learning method example, the machine learning model 204 may be trained using pressure data from a conduit monitoring system that is known to be associated with an ideal conduit to produce a predictive model 206 that is reflective of normal conduit conditions. Once the normal predictive model 206 has been generated, a predictive algorithm thereof can identify depositions and leaks within a conduit of interest from anomalies in new pressure (sensor) data 214 to which the predictive model 206 is subsequently applied, on the basis of an amount of deviation from the normal model. The predictive algorithm may employ, without limitation, clustering, anomaly detection, or other techniques to this end.

According to some examples, a supervised or unsupervised artificial neural network (ANN) can also be trained and utilized to locate and track the movement of a transient object. A deep learning network can also be trained and employed. Ensembling techniques, such as, for example, bootstrapping or aggregation, may also be utilized regardless of the modeling method used. Ensembling techniques may also be used to reduce model variance. Feature engineering techniques may also be employed during training of the machine learning model, such as for purposes of extracting features (e.g., key attributes) from the raw training data and using the features to improve the machine learning model training process. Likewise, feature selection techniques can be used to remove features from the raw training data that are not necessary to training of the machine learning model.

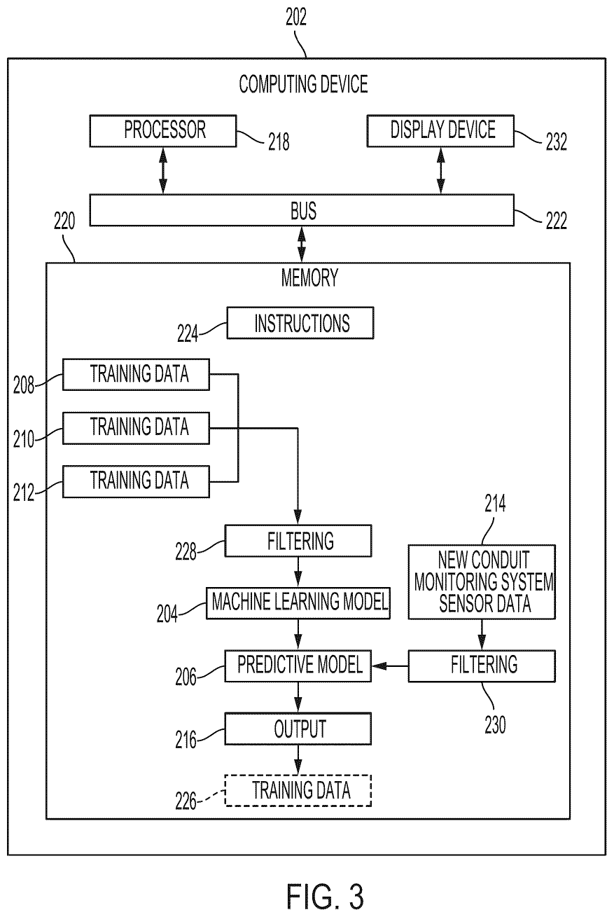

FIG. 3 is a block diagram of an example of the computing device 202 of the deposition and leak detection system 200, which may be used to execute the predictive model 206 to identify and locate a deposition or leak in a hydrocarbon well conduit according to one example. While FIG. 3 depicts the computing device 202 as including certain components, other examples may involve more, fewer, or different components than are shown in FIG. 3. In an example, the computing device 202 may be implemented as the deposition and leak detection system 200, as described above with respect to FIG. 2.

As shown, the computing device 202 includes a processor 218 communicatively coupled to a memory 220 by a bus 222. The processor 218 can include one processor or multiple processors. Non-limiting examples of the processor 218 include a Field-Programmable Gate Array (FPGA), an application specific integrated circuit (ASIC), a microprocessor, or any combination of these. Instructions 224 may be stored in the memory 220. The instructions are executable by the processor for causing the processor to perform various operations. In some examples, the instructions 224 can include processor specific instructions generated by a compiler or an interpreter from code written in any suitable computer-programming language, such as C, C++, C#, or Java.

The memory 220 can include one memory device or multiple memory devices. The memory 220 can be non-volatile and may include any type of memory device that retains stored information when powered off. Non-limiting examples of the memory 220 include electrically erasable and programmable read-only memory (EEPROM), flash memory, or any other type of non-volatile memory. At least some of the memory device includes a non-transitory computer-readable medium from which the processor 218 can read instructions 224. A non-transitory computer-readable medium can include electronic, optical, magnetic, or other storage devices capable of providing the processor 218 with the instructions 224 or other program code. Non-limiting examples of a non-transitory computer-readable medium include magnetic disk(s), memory chip(s), ROM, random-access memory (RAM), an ASIC, a configured processor, optical storage, or any other medium from which a computer processor can read the instructions 224.

The computing device 202 may include the machine learning model 204 that can receive the training data in the first training dataset 208, the second training dataset 210, and/or the third training dataset 212. The machine learning model 204 may be trained with the training data in the first training dataset 208, the second training dataset 210, and/or the third training dataset 212 by the computing device 202 to generate the predictive model 206. The computing device 202 can execute the predictive model 206 on new pressure data 214 received from or produced by a conduit monitoring system to generate the predictive output 216 relative to the presence of a deposition or a leak in a conduit of interest associated with the pressure data to which the predictive model 206 was applied. When the machine learning model 204 is trained using a semi-supervised learning method, the output 216 of the predictive model 206 may include predicted labels for unlabeled data in the first training dataset 208, the second training dataset 210, and/or the third training dataset 212, which can function as additional training data 226 that can be used to further train the machine learning model 204 or to train a new machine learning model.

The output 216 can provide useful information to a user of the deposition and leak detection system 200. For example, the output may generate a notification that at least a identifies a location and a magnitude of the deposition or the leak. The output may indicate that a cleaning or other remediation operation is in order. Similarly, identification of a leak in a conduit may indicate that a repair is required. Timely deposition and leak identification can also help to avoid conduit damage, production reductions, or shutdowns. The (predictive) output 216, including a notification generated as part of the output, may be textual and/or graphical in nature. In an example, the output 216, in the form of a generated notification or otherwise, may be presented on a display 232 that communicates with the processor 218 via the bus 222.

Pressure data received by a deposition and leak detection system will commonly be affected by noise, such as pump noise or other extraneous noise, and may occur across a wide frequency range. Consequently, the computing device 202 of the deposition and leak detection system 200 can include filtering functionality. For example, the computing device 202 may execute a first filtering operation 228 that can be applied to the pressure data in the first training dataset 208, the second training dataset 210, and/or the third training dataset 212 to refine the pressure data prior to its use in training the machine learning model 204. Similarly, the computing device 202 may execute a second filtering operation 230 that can be applied to new conduit monitoring system pressure data associated with a conduit of interest prior to application of the predictive model 206 thereto.

In an example, the first filtering operation 228 can be utilized to remove noise from the training data used to train the machine learning model 204 and to focus on a frequency range likely to be of interest to the deposition and leak detection system 200. In an example, the second filtering operation 230 can be applied for similar purposes to new pressure data associated with a conduit of interest to which the predictive model 206 is applied. Either or both of the first filtering operation 228 and the second filtering operation 230 may be a two-step process. For example, a low-pass filter such as, without limitation, a Butterworth filter, may be initially applied to the training data to remove or attenuate portions thereof that are associated with frequencies higher than a frequency range of interest to the deposition and leak detection system 200. A second filter, such as for example, a Gaussian filter or a notch filter, may then be applied to the once-filtered pressure data to better isolate pressure data points that reside within a frequency range of interest. The frequency range of interest may be, for example, between approximately 5-10 Hz. In at least one example, the frequency range of interest is between e.g., 6-7 Hz. Filtered training data may subsequently be used to train the machine learning model 204, which can make the training process more efficient and may result in a more accurate predictive model.

During a test conducted by the conduit monitoring system 100, the overall length of time during which a pressure wave propagates in the conduit and continues to result in measurable pressure wave reflections may far exceed a time period of interest, which may be a time period bounded by the largest points of created acoustic energy in the conduit during the test. This commonly occurs, for example, over a time period beginning at a first point where a valve is closed to produce a pressure wave in the conduit monitored by the conduit monitoring system 100, and a subsequent second point where the valve is reopened. As a machine learning model can be trained on pressure data collected over the course of many (e.g., thousands of) monitoring operations, it can be advantageous to focus on the pressure profile in the conduit during only a time period of interest.

Examples of the computing device 202 of the deposition and leak detection system 200 can also be provided with pressure data corresponding to an expected pressure profile within an ideal conduit having a given set of characteristics (e.g., diameter, length, fluid flow rate). The expected pressure profile may be the result of direct observation, may be derived by other experimentation, may be determined through the use of physics-based models, etc. When a like or similar conduit includes a deposition or a leak, the observed conduit pressure profile associated with the conduit will deviate from the expected pressure profile during at least a portion of the time period of interest. This deviation may be indicative of the characteristics of a deposition in the conduit, may be a parameter of interest during training of the machine learning model 204, and may be used by the predictive model 206 to predict a deposition or leak in a conduit of interest when applied to new pressure data associated therewith.

Conduit pressures and pressure profiles, the identification and location of a deposition, the size of a deposition, etc., can be calculated by the predictive model 206 according to known techniques. For example, by knowing, measuring or otherwise determining other characteristics about a conduit of interest (e.g., conduit length and diameter) and the fluid in the conduit (e.g., temperature, flow rate), mathematical equations such as but not necessarily limited to the mathematical equations disclosed in U.S. Pat. No. 6,993,963 B1, can be used by the predictive model to calculate pressures and to identify and locate a deposition in a conduit of interest.

The predictive model 206 of the deposition and leak detection system 200 can calculate an average conduit pressure based on pressure measurements for a conduit of interest collected (e.g., recorded) by and received from a conduit monitoring system according to one example. More specifically, the predictive model 206 can calculate an independent pressure profile for each of a plurality of monitoring operations (tests) on the conduit of interest, and can calculate an average pressure profile of the plurality of independent pressure profiles.

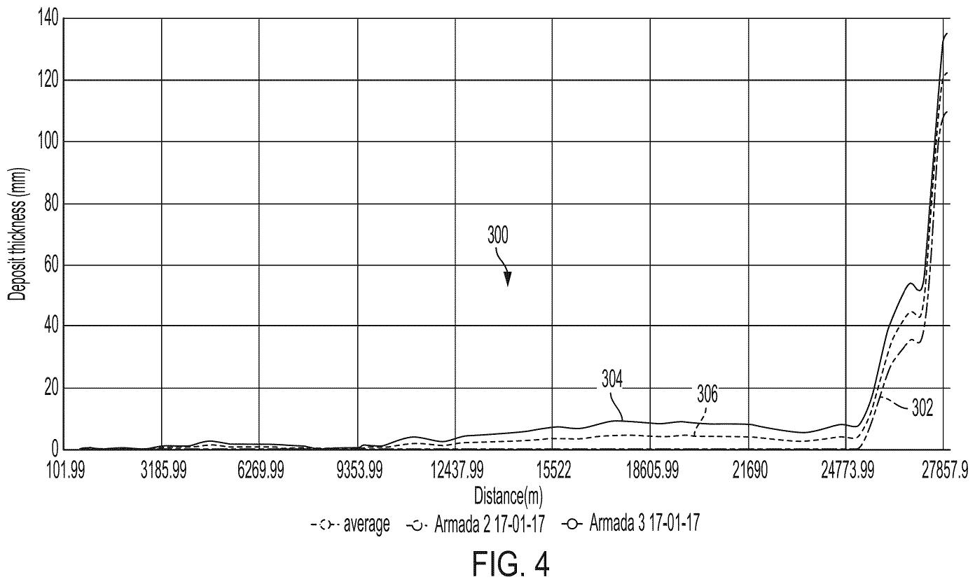

Considering the calculated conduit pressures and using a known value of the velocity with which a pressure wave generated by the conduit monitoring system propagated through the fluid in the conduit of interest during each test, a location and a thickness profile of a deposition located in the conduit of interest can be predicted by using the computing device 202 of the deposition and leak detection system 200 to execute the predictive model 206 on the pressure measurements. A graphic representation 300 of the thickness and location of a deposition indicated by the pressure measurements associated with the calculated pressures is depicted in FIG. 4 according to one example. As shown in this example, a first predicted deposition thickness profile 302 and location is calculated based on the pressure measurements used to calculate a first pressure profile, and a second predicted deposition thickness profile 304 and location is calculated based on the pressure measurements used to calculate a second pressure profile. An average predicted deposition thickness profile 306 calculated from the pressure measurements associated with the first deposition thickness profile 302 and the pressure measurements associated with the second deposition thickness profile 304 is further depicted in FIG. 4.

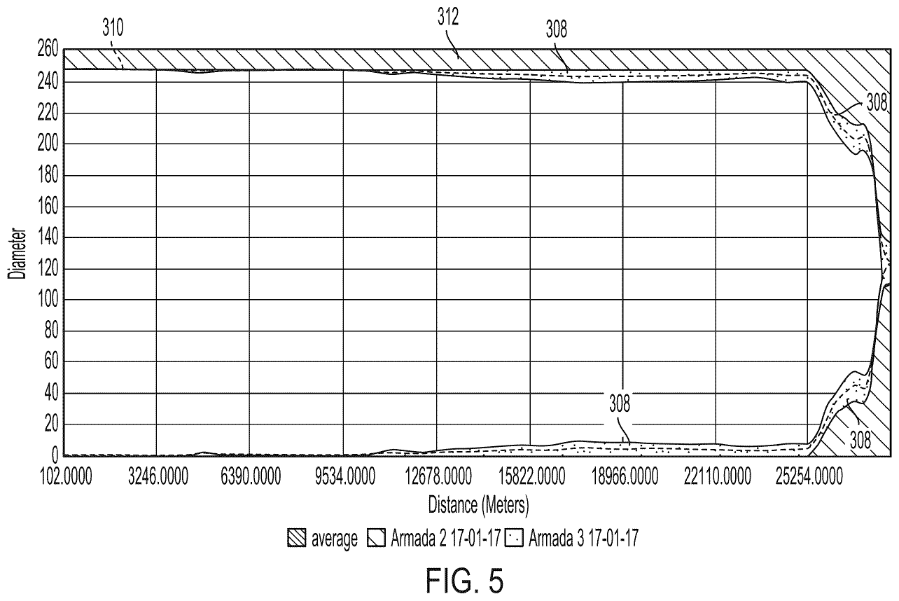

As represented in the example of FIG. 5, the pressure measurements used to generate the predicted deposition thickness profiles 302, 304, 306 of FIG. 4 may also be used by the deposition and leak detection system 200 to output a visual representation of the predicted deposition 308 in a manner that more clearly and realistically relates the thickness profile of the deposition 308 to an inner diameter 310 of the conduit of interest 312. While the visual representation of FIG. 5 is two-dimensional, a three-dimensional visual representation can be provided in other examples in lieu of or in addition to a two-dimensional visual representation. The visual representation of FIG. 5 can help a user of the deposition and leak detection system 200 to more easily visualize and comprehend the location (including the starting point) of the deposition 308, as well as the potential effect of the deposition 308 thickness on fluid flow through the conduit of interest.

As described above, examples of a deposition and leak detection system, such as the deposition and leak detection system 200, can also identify and locate leaks in a conduit of interest based on pressure measurements received from a conduit monitoring system relative to the conduit of interest. A trained machine learning model of the deposition and leak detection system 200 can analyze pressure measurements received from a conduit monitoring system to identify an anomalous pressure gain associated with a reduced area for fluid/gas flow within the conduit caused by a deposition, or an anomalous pressure loss associated with an expanded area for fluid/gas flow within the conduit caused by a leak. Determining that a deposition or a leak is present in a conduit can be based on modeling the flow of a fluid/gas, and the direction of a pressure transient with respect to the fluid/gas flow direction. Both data and designations for each deposition or leak use case can also be used to support a machine learning model training dataset.

In a similar manner to that described above with respect to the identification of depositions, conduit pressures and pressure profiles, the identification and location of a leak, the magnitude of a leak, etc., can be calculated by the predictive model 206 according to known techniques. For example, and without limitation, the aforementioned mathematical equations disclosed in U.S. Pat. No. 6,993,963 B1 can also be used to by the predictive model 206 to calculate conduit pressures and to identify and locate a leak in a conduit. Other mathematical equations may also be used.

Considering the calculated conduit pressures and using a known value of the velocity with which a pressure wave generated by the conduit monitoring system propagated through the fluid in the conduit of interest during each test, a location and size of a leak in the conduit of interest can be predicted by using the computing device 202 of the deposition and leak detection system 200 to execute the predictive model 206 on the pressure measurements. A graphic representation of the size and location of a leak indicated by the pressure measurements associated with the calculated pressures may be presented to a user. A first predicted leak size profile and location can be calculated based on the pressure measurements used to calculate a first pressure profile, and a second predicted leak size profile and location can be calculated based on the pressure measurements used to calculate a second pressure profile. An average predicted leak size profile calculated from the pressure measurements associated with the first leak size profile and the pressure measurements associated with the second leak size profile may also be presented to a user.

In some examples, pressure measurements used to generate the above-described predicted leak size profiles may also be used by the deposition and leak detection system 200 to output a visual representation of the predicted leak in a manner that more clearly and realistically indicates the size of the leak relative to the size (e.g., inner diameter) of the conduit of interest. The visual representation of a predicted leak may be two-dimensional or three-dimensional. A visual representation of a predicted leak can help a user of the deposition and leak detection system 200 to more easily visualize and comprehend the location and size of the leak, as well as the potential effect of the leak on fluid flow through the conduit of interest.

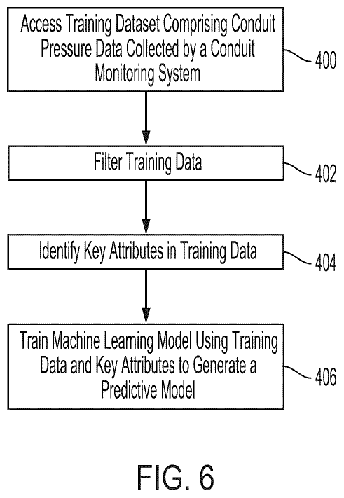

FIG. 6 is a flow chart representing a method of training a machine learning model to identify and locate a deposition or a leak in a hydrocarbon well conduit according to one example. According to the method example of FIG. 6, a training dataset comprising a multitude of pressure data samples for a conduit of a hydrocarbon well operation is accessed at block 400 by a processor, such as a processor of an above-described deposition and leak detection system. At block 402, the processor can filter the pressure data of the training dataset, such as to remove noise and to focus the pressure data of the training dataset on a frequency range of interest. The frequency range of interest may be, at least in some examples, between 6 Hz to 7 Hz. The pressure data may be filtered using a low-pass filter followed by a second filter. In an example, the low-pass filter may be a Butterworth filter and the second filter can be a Gaussian filter or a notch filter. At block 404, the processor can identify key attributes in the pressure data samples of the training dataset. In an example, one key attribute of the plurality of key attributes may be a point of largest measured acoustic energy in the conduit. In some examples, the key attributes in the pressure data samples can be identified from a first derivative of each of the pressure data samples, where the first derivative is calculated after filtering of the pressure data samples. As represented in block 406, the processor may thereafter train a machine learning model using the training dataset and the key attributes to generate a predictive model.

In some examples, a deposition or a leak in a conduit of interest may be predicted after generating the predictive model, by applying the predictive model to pressure measurements associated with the conduit of interest. When the presence of a deposition or a leak is predicted, an action may be taken. For example, a notification indicating a location and a magnitude of the deposition or the leak may be generated, a maintenance procedure may be scheduled, or a remediation action relative to the deposition or the leak may be initiated.

For purposes of illustration, various examples have been provided above relative to hydrocarbon well conduits, fluids, and operations. However, it should be understood that the examples can also be used to identify and locate anomalies such as depositions or leaks in other types of conduits. For example, a system can be used to identify and locate anomalies such as depositions or leaks in conduits carrying water, hydrogen, carbon dioxide, or other fluids. In one particular example, a system and method can be used to identify and locate anomalies such as depositions or leaks in a conduit of a carbon capture, utilization and storage (CCUS) operation, where carbon dioxide is captured from a source and transported to another location for use or for geologic sequestration in an underground formation.

According to aspects of the present disclosure, a system, a method, and a non-transitory computer-readable medium, are provided according to one or more of the following examples. As used below, any reference to a series of examples is to be understood as a reference to each of those examples disjunctively (e.g., “Examples 1-4” is to be understood as “Examples 1, 2, 3, or 4”).

Example 1 is a system, comprising: a processor; and a memory including instructions that are executable by the processor for causing the processor to: access a training dataset comprising a multitude of measured pressure data samples for a conduit of a hydrocarbon well operation; filter the pressure data samples of the training dataset by applying a low-pass filter to the pressure data samples and by applying a second filter to the pressure data samples subsequent to applying the low-pass filter to the pressure data samples; identify a plurality of key attributes in each of the pressure data samples, at least one key attribute of the plurality of key attributes being a point of largest measured acoustic energy in the conduit; and train a machine learning model using the training dataset and the plurality of key attributes to minimize standard deviation and mean average between distance to blockage or distance to leak predictions calculated from at least some of the pressure data samples in the training dataset, to generate a predictive model.

Example 2 is the system of example 1, wherein: the pressure data is produced by a conduit monitoring system configured to introduce a pressure wave into the conduit and to measure a magnitude of reflected pressure waves using at least one sensor; the conduit monitoring system is communicatively coupled to a computing device of the deposition and leak detection system, the computing device including the processor, the memory, and the instructions; and the instructions are further executable by the processor for causing the processor to receive the pressure measurements from the conduit monitoring system.

Example 3 is the system of example 2, wherein the plurality of key attributes further includes a pressure data sample characteristic selected from the group consisting of a point at which a mechanism used by the conduit monitoring system to introduce the pressure wave into the conduit is turned off; a point at which the pressure in the conduit begins to recover from introduction of the pressure wave into the conduit, a time period of interest of a total time period for which the pressure data was produced by the conduit monitoring system, and combinations thereof.

Example 4 is the system of example 1, wherein: the low-pass filter and the second filter are usable in combination to remove noise from the pressure data samples and to focus the training dataset on a frequency range of interest of between 6 Hz to 7 Hz; and the low-pass filter is a Butterworth filter and the second filter is a Gaussian filter or a notch filter.

Example 5 is the system of example 1, wherein the instructions are further executable by the processor for causing the processor to: after filtering of the pressure data samples, calculate at least a first derivative of each of the pressure data samples; and identify the plurality of key attributes in each of the pressure data samples from the first derivative of each of the pressure data samples.

Example 6 is the system of example 1, wherein the training dataset includes a first set of pressure data associated with a conduit known to have a deposition, a second set of pressure data associated with a conduit known to have a leak, and a third set of pressure data associated with an ideal conduit.

Example 7 is the system of example 1, wherein the instructions are further executable by the processor for causing the processor to: predict a location and a size of a deposition or a leak in a conduit of interest by applying the predictive model to measured pressure data associated with the conduit of interest and analyzing a difference between an observed pressure profile defined by the measured pressure data and an expected pressure profile for an ideal conduit; and output a command to execute an action selected from the group consisting of generating a notification indicating a location and a magnitude of the deposition or the leak, scheduling a maintenance procedure, initiating a remediation action relative to the deposition or the leak, and combinations thereof.

Example 8 is a computer-implemented method comprising: accessing, by a processor, a training dataset comprising a multitude of measured pressure data samples for a conduit of a hydrocarbon well operation; filtering, by the processor, the pressure data samples of the training dataset by applying a low-pass filter to the pressure data samples and applying a second filter to the pressure data samples subsequent to applying the low-pass filter to the pressure data samples; identifying, by the processor, a plurality of key attributes in each of the pressure data samples, at least one key attribute of the plurality of key attributes being a point of largest measured acoustic energy in the conduit; and training, by the processor, a machine learning model using the training dataset and the plurality of key attributes to minimize standard deviation and mean average between distance to blockage or distance to leak predictions calculated from at least some of the pressure data samples in the training dataset, to generate a predictive model.

Example 9 is the computer-implemented method of example 8, wherein the training dataset includes a first set of pressure data associated with a conduit known to have a deposition, a second set of pressure data associated with a conduit known to have a leak, and a third set of pressure data associated with an ideal conduit.

Example 10 is the computer-implemented method of example 8, wherein: the low-pass filter and the second filter are usable in combination to remove noise from the pressure data samples and to focus the training dataset on a frequency range of interest of between 6 Hz to 7 Hz; and the low-pass filter is a Butterworth filter and the second filter is a Gaussian filter or a notch filter.

Example 11 is the computer-implemented method of example 8, further comprising: after filtering of the pressure data samples, calculating, by the processor, a first derivative of each of the pressure data samples; and identifying, by the processor, the plurality of key attributes in each of the pressure data samples from the first derivative of each of the pressure data samples.

Example 12 is the computer-implemented method of example 8, further comprising: predicting, by the processor, a location and a size of a deposition or a leak in a conduit of interest by applying the predictive model to measured pressure data associated with the conduit of interest and analyzing a difference between an observed pressure profile defined by the measured pressure data and an expected pressure profile for an ideal conduit; and in response to predicting a deposition or a leak in the conduit of interest, outputting by the processor, a command selected from the group consisting of generating a notification indicating a location and a magnitude of the deposition or the leak, scheduling a maintenance procedure, initiating a remediation action relative to the deposition or the leak, and combinations thereof.

Example 13 is the computer-implemented method of example 8, wherein the remediation action is launching a cleaning pig or a robotic conduit leak repair device.

Example 14 is a non-transitory computer-readable medium comprising instructions that are executable by a processor for causing the processor to: access a training dataset comprising a multitude of measured pressure data samples for a conduit of a hydrocarbon well operation; filter the pressure data samples of the training dataset by applying a low-pass filter to the pressure data samples and by applying a second filter to the pressure data samples subsequent to applying the low-pass filter to the pressure data samples; identify a plurality of key attributes in each of the pressure data samples, at least one key attribute of the plurality of key attributes being a point of largest measured acoustic energy in the conduit; and train a machine learning model using the training dataset and the plurality of key attributes to minimize standard deviation and mean average between distance to blockage or distance to leak predictions calculated from at least some of the pressure data samples in the training dataset, to generate a predictive model.

Example 15 is the non-transitory computer-readable medium of example 14, wherein: the pressure data is produced by a conduit monitoring system configured to introduce a pressure wave into the conduit and to measure a magnitude of reflected pressure waves using at least one sensor; the conduit monitoring system is communicatively coupled to a computing device of the deposition and leak detection system, the computing device including the processor and the instructions; and the instructions are further executable by the processor for causing the processor to receive the pressure measurements from the conduit monitoring system.

Example 16 is the non-transitory computer-readable medium of example 15, wherein the plurality of key attributes further includes a pressure data sample characteristic selected from the group consisting of a point at which a mechanism used by the conduit monitoring system to introduce the pressure wave into the conduit is turned off; a point at which the pressure in the conduit begins to recover from introduction of the pressure wave into the conduit, a time period of interest of a total time period for which the pressure data was produced by the conduit monitoring system, and combinations thereof.

Example 17 is the non-transitory computer-readable medium of example 14, wherein: the low-pass filter and the second filter are usable in combination to remove noise from the pressure data samples and to focus the training dataset on a frequency range of interest of between 6 Hz to 7 Hz; and the low-pass filter is a Butterworth filter and the second filter is a Gaussian filter or a notch filter.

Example 18 is the non-transitory computer-readable medium of example 14, wherein the instructions are further executable by the processor for causing the processor to: after filtering of the pressure data samples, calculate at least a first derivative of each of the pressure data samples; and identify the plurality of key attributes in each of the pressure data samples from the first derivative of each of the pressure data samples.

Example 19 is the non-transitory computer-readable medium of example 14, wherein: the training dataset includes a first set of pressure data associated with a conduit known to have a deposition, a second set of pressure data associated with a conduit known to have a leak, and a third set of pressure data associated with an ideal conduit; and the instructions are executable by a processor for causing the processor to train the machine learning model using a supervised, a semi-supervised, or an unsupervised machine learning method.

Example 20 is the non-transitory computer-readable medium of example 14, wherein the instructions are further executable by the processor for causing the processor to: predict a location and a size of a deposition or a leak in a conduit of interest by applying the predictive model to measured pressure data associated with the conduit of interest and analyzing a difference between an observed pressure profile defined by the measured pressure data and an expected pressure profile for an ideal conduit; and output a command to execute an action selected from the group consisting of generating a notification indicating a location and a magnitude of the deposition or the leak, scheduling a maintenance procedure, initiating a remediation action relative to the deposition or the leak, and combinations thereof.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system, comprising:
a processor; and
a memory including instructions that are executable by the processor for causing the processor to:
access a training dataset comprising a multitude of measured pressure data samples for a conduit of a hydrocarbon well operation;
filter the pressure data samples of the training dataset by applying a low-pass filter to the pressure data samples and by applying a second filter to the pressure data samples subsequent to applying the low-pass filter to the pressure data samples;
identify a plurality of key attributes in each of the pressure data samples, at least one key attribute of the plurality of key attributes being a point of largest measured acoustic energy in the conduit; and
train a machine learning model using the training dataset and the plurality of key attributes to minimize standard deviation and mean average between distance to blockage or distance to leak predictions calculated from at least some of the pressure data samples in the training dataset, to generate a predictive model.

2. The system of claim 1, wherein:
the pressure data samples are produced by a conduit monitoring system configured to introduce a pressure wave into the conduit and to measure a magnitude of reflected pressure waves using at least one sensor;
the conduit monitoring system is communicatively coupled to a computing device of the system, the computing device including the processor, the memory, and the instructions; and
the instructions are further executable by the processor for causing the computing device to receive the pressure data samples from the conduit monitoring system.

3. The system of claim 2, wherein the plurality of key attributes further includes a pressure data sample characteristic selected from the group consisting of a point at which a mechanism used by the conduit monitoring system to introduce the pressure wave into the conduit is turned off; a point at which the pressure in the conduit begins to recover from introduction of the pressure wave into the conduit, a time period of interest of a total time period for which the pressure data was produced by the conduit monitoring system, and combinations thereof.

4. The system of claim 1, wherein:
the low-pass filter and the second filter are usable in combination to remove noise from the pressure data samples and to focus the training dataset on a frequency range of interest of between 6 Hz to 7 Hz; and
the low-pass filter is a Butterworth filter and the second filter is a Gaussian filter or a notch filter.

5. The system of claim 1, wherein the instructions are further executable by the processor for causing the processor to:
after filtering of the pressure data samples, calculate at least a first derivative of each of the pressure data samples; and
identify the plurality of key attributes in each of the pressure data samples from the first derivative of each of the pressure data samples.

6. The system of claim 1, wherein the training dataset includes a first set of pressure data associated with a conduit known to have a deposition, a second set of pressure data associated with a conduit known to have a leak, and a third set of pressure data associated with an ideal conduit.

7. The system of claim 1, wherein the instructions are further executable by the processor for causing the processor to:
predict a location and a size of a deposition or a leak in a conduit of interest by applying the predictive model to measured pressure data associated with the conduit of interest and analyzing a difference between an observed pressure profile defined by the measured pressure data and an expected pressure profile for an ideal conduit; and
output a command to execute an action selected from the group consisting of generating a notification indicating a location and a magnitude of the deposition or the leak, scheduling a maintenance procedure, initiating a remediation action relative to the deposition or the leak, and combinations thereof.

8. A computer-implemented method comprising:
accessing, by a processor, a training dataset comprising a multitude of measured pressure data samples for a conduit of a hydrocarbon well operation;
filtering, by the processor, the pressure data samples of the training dataset by applying a low-pass filter to the pressure data samples and applying a second filter to the pressure data samples subsequent to applying the low-pass filter to the pressure data samples;
identifying, by the processor, a plurality of key attributes in each of the pressure data samples, at least one key attribute of the plurality of key attributes being a point of largest measured acoustic energy in the conduit; and
training, by the processor, a machine learning model using the training dataset and the plurality of key attributes to minimize standard deviation and mean average between distance to blockage or distance to leak predictions calculated from at least some of the pressure data samples in the training dataset, to generate a predictive model.

9. The computer-implemented method of claim 8, wherein the training dataset includes a first set of pressure data associated with a conduit known to have a deposition, a second set of pressure data associated with a conduit known to have a leak, and a third set of pressure data associated with an ideal conduit.

10. The computer-implemented method of claim 8, wherein:
the low-pass filter and the second filter are usable in combination to remove noise from the pressure data samples and to focus the training dataset on a frequency range of interest of between 6 Hz to 7 Hz; and
the low-pass filter is a Butterworth filter and the second filter is a Gaussian filter or a notch filter.

11. The computer-implemented method of claim 8, further comprising:
after filtering of the pressure data samples, calculating, by the processor, a first derivative of each of the pressure data samples; and
identifying, by the processor, the plurality of key attributes in each of the pressure data samples from the first derivative of each of the pressure data samples.

12. The computer-implemented method of claim 8, further comprising:
predicting, by the processor, a location and a size of a deposition or a leak in a conduit of interest by applying the predictive model to measured pressure data associated with the conduit of interest and analyzing a difference between an observed pressure profile defined by the measured pressure data and an expected pressure profile for an ideal conduit; and
in response to predicting a deposition or a leak in the conduit of interest, outputting by the processor, a command selected from the group consisting of generating a notification indicating a location and a magnitude of the deposition or the leak, scheduling a maintenance procedure, initiating a remediation action relative to the deposition or the leak, and combinations thereof.

13. The computer-implemented method of claim 8, wherein the remediation action is launching a cleaning pig or a robotic conduit leak repair device.

14. A non-transitory computer-readable medium comprising instructions that are executable by a processor for causing the processor to:
access a training dataset comprising a multitude of measured pressure data samples for a conduit of a hydrocarbon well operation;
filter the pressure data samples of the training dataset by applying a low-pass filter to the pressure data samples and by applying a second filter to the pressure data samples subsequent to applying the low-pass filter to the pressure data samples;
identify a plurality of key attributes in each of the pressure data samples, at least one key attribute of the plurality of key attributes being a point of largest measured acoustic energy in the conduit; and
train a machine learning model using the training dataset and the plurality of key attributes to minimize standard deviation and mean average between distance to blockage or distance to leak predictions calculated from at least some of the pressure data samples in the training dataset, to generate a predictive model.

15. The non-transitory computer-readable medium of claim 14, wherein:
the pressure data samples are produced by a conduit monitoring system configured to introduce a pressure wave into the conduit and to measure a magnitude of reflected pressure waves using at least one sensor;
the conduit monitoring system is communicatively coupled to a computing device of the system, the computing device including the processor and the instructions; and
the instructions are further executable by the processor for causing the computing device to receive the pressure data samples from the conduit monitoring system.

16. The non-transitory computer-readable medium of claim 15, wherein the plurality of key attributes further includes a pressure data sample characteristic selected from the group consisting of a point at which a mechanism used by the conduit monitoring system to introduce the pressure wave into the conduit is turned off; a point at which the pressure in the conduit begins to recover from introduction of the pressure wave into the conduit, a time period of interest of a total time period for which the pressure data was produced by the conduit monitoring system, and combinations thereof.

17. The non-transitory computer-readable medium of claim 14, wherein:
the low-pass filter and the second filter are usable in combination to remove noise from the pressure data samples and to focus the training dataset on a frequency range of interest of between 6 Hz to 7 Hz; and
the low-pass filter is a Butterworth filter and the second filter is a Gaussian filter or a notch filter.

18. The non-transitory computer-readable medium of claim 14, wherein the instructions are further executable by the processor for causing the processor to:
after filtering of the pressure data samples, calculate at least a first derivative of each of the pressure data samples; and
identify the plurality of key attributes in each of the pressure data samples from the first derivative of each of the pressure data samples.

19. The non-transitory computer-readable medium of claim 14, wherein the training dataset includes a first set of pressure data associated with a conduit known to have a deposition, a second set of pressure data associated with a conduit known to have a leak, and a third set of pressure data associated with an ideal conduit.

20. The non-transitory computer-readable medium of claim 14, wherein the instructions are further executable by the processor for causing the processor to:
predict a location and a size of a deposition or a leak in a conduit of interest by applying the predictive model to measured pressure data associated with the conduit of interest and analyzing a difference between an observed pressure profile defined by the measured pressure data and an expected pressure profile for an ideal conduit; and
output a command to execute an action selected from the group consisting of generating a notification indicating a location and a magnitude of the deposition or the leak, scheduling a maintenance procedure, initiating a remediation action relative to the deposition or the leak, and combinations thereof.
